(19) United States
(12) Patent Application Publication
(10) Pub. No.: US 2025/0259590 A1
(43) Pub. Date: Aug. 14, 2025

(54) SECTIONAL DRIVING

(71) Applicant: VueReal Inc., Waterloo (CA)

(72) Inventor: Gholamreza CHAJI, Kitchener (CA)

(73) Assignee: VueReal Inc., Waterloo, ON (CA)

(21) Appl. No.: 18/996,077

(22) PCT Filed: Jul. 26, 2024
(86) PCT No.: PCT/CA2024/050995

§ 371 Date: Jan. 17, 2025

Related U.S. Application Data
(60) Provisional application No. 63/515,743, filed on Jul. 26, 2023.

(51) Int. Cl. G09G 3/30

(52) U.S. Cl. CPC G09G 3/30; G09G 2300/0804; G09G 2300/0842; G09G 2320/0233; G09G 2320/041

(57) ABSTRACT

The present disclosure discloses an optoelectronic array, such as a display, which includes an array of pixels which performs specific functions. In particular, it discloses methods to update a section of pixel arrays and enable segment programming with a pixel architecture. Further, it discloses an optoelectronic system that enables updating a section of the arrays.

### FIELD OF THE INVENTION

The present disclosure relates to an optoelectronic array, such as a display, which includes an array of pixels which performs specific functions.

### SUMMARY

The present invention relates to a method to update a section of pixel arrays, the method comprising, having a pixel array divided into sections, having an independent set of programming signal for each section, arranging the programming signals in rows and data lines in columns, having sections on the right side are connected to right programming signals and sections on the left side are connected to left programming signals for a 2×2 sectional arrangement and updating each section independently.

The present invention relates to a method to enable segment programming with a pixel architecture comprising, having a pixel comprising of a driving part, a function part and two series switches, having the function part performing primary array function, controlling the two switches by two separate programming signals, programming a pixel wherein both programming signals are activated and creating sections based on arrangement of the first and second programming signals.

The present invention relates to a method to enable segment programming with a pixel architecture comprising, having at least one pixel with its a memory for data, wherein the pixel memory in the section is daisy chained, and a data signal for passing the data to the pixel and a data-out signal for passing the signal to the a pixel, and a control signal controlling a data path to the memory in a first section or diverting to a next section.

### BRIEF DESCRIPTION OF THE DRAWINGS

The foregoing and other advantages of the disclosure will become apparent upon reading the following detailed description and upon reference to the drawings.

FIG. 1 shows an array divided into sections.

FIG. 2 shows related pixel architectures that enable segment programming.

FIG. 3 shows a related pixel architecture with digital data.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The present invention relates to an optoelectronic array, such as a display, which includes an array of pixels which performs specific functions. The pixels are programmed with specific digital or analog values; sometimes, a signal is read back from each pixel. There are data lines, bias lines, power lines, and select/program lines. Data lines and program lines are generally arranged in columns and rows. So that when a write line is enabled, the data lines can update the value of pixels connected to the write line.

The following description describes a system and method of optoelectronic array programming.

The power consumption associated with the optoelectronic array comes from the power associated with the pixel function and updating/programming the pixel value or reading the pixel sensing value.

To reduce the power associated with the updating/programming, one can reduce the frequency of the updates when possible. However, in this case, the entire array is still updated during each update cycle.

The inventions presented here enable updating a section of the arrays.

The array is divided into sections that can be programmed independently in one embodiment. And each section has separate written signals. As a result, the number of program signals increases significantly.

Two sets of programming signals are used in one related embodiment. One in the row arrangement and another one in the column arrangement. As a result, both rows and columns should be activated to program a pixel.

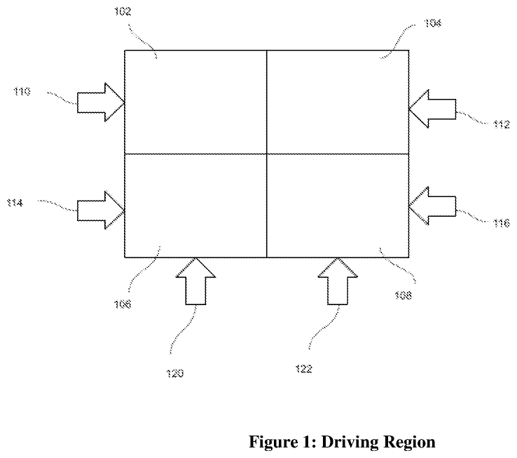

FIG. 1 shows an array divided into sections 102, 104, 106, and 108. Each section can be updated independently. Here, it shows the programming signals 110, 112, 114, and 116 are arranged in rows, and the data lines 120 and 122 are arranged in columns. However, it can be noted that the orientation can be different. Here, for each section, there is an independent set of programming signals. If the display is divided into four sections in a 2×2 arrangement, the sections on the right side are connected to the right programming signals 110 and 114 and the sections on the left side are connected to the left programming signals 112 and 116. In another related embodiment, the programming signals sets can be on either side for each section. The data come to update the display also include the section that will be updated. The data are directed to sections intended for update and the signals for that sections are activated. The data signals may include biasing conditions, data inputs and frame rate. Programming signals include the select signals that activate the pixel for accepting programing data, emission signals that control the emission time and frame rate of the pixel. Also, each section can have a different emission duty cycle optimized for the brightness, power or colour of that section. The pixel may have compensation techniques that can be controlled in section or individually. The compensation technique is used to improve the pixel performance such as uniformity, reliability under prolonged use or different environmental conditions. The environmental conditions can be temperature, ambient light and so on.

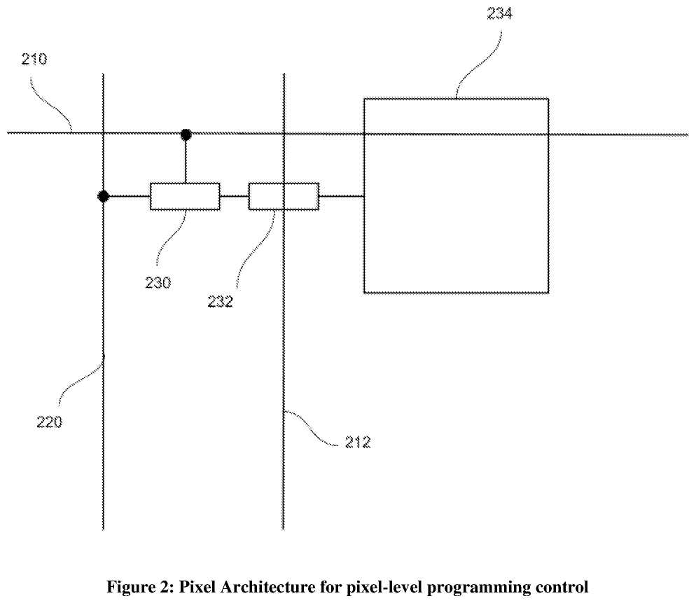

FIG. 2 shows related pixel architectures that enable segment programming. Here, the pixel includes a driving and function part 234; and two series switches, 230 and 232. The function part 234 performs the primary array function. For example, the display pixel, the function part, creates light based on the programming value. The two switches are controlled by two programming signals, 210 and 212, where one programming signal, 212, is parallel with the data line 220, and the second programming signal, 210, is orthogonal to the data line 220. The switch connected to the first programming line is closer to the functional part of the pixel. In this case, if the first signal is not enabled, the pixel does not lose its current state, and the data line will not impact the internal state of the pixel. This structure allows updating sections as small as one pixel and as large as the entire array. The pixel may need more than one set of series switches to prevent losing its status.

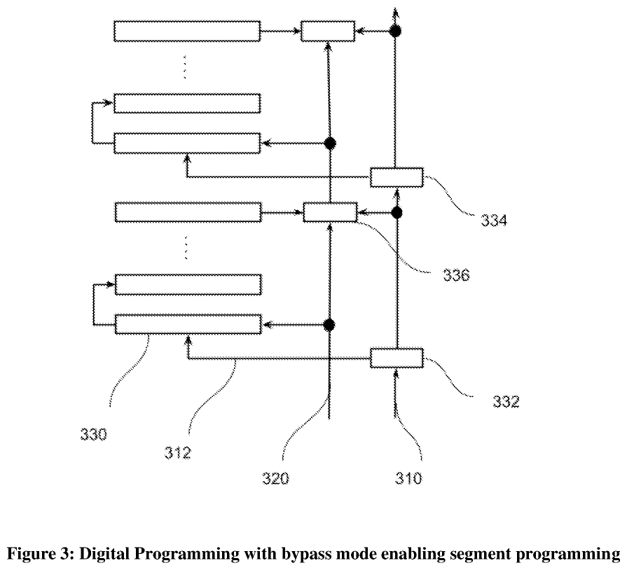

FIG. 3 shows a related pixel architecture with digital data. The section can include at least one pixel, and each pixel has a memory 330. The pixel memory in the section is daisy chained. Here, the data 320 is passed to the pixel memory 330 in one section or diverted to the next section. And the signal 310 that controls the path of the data is passed alongside the data.

The section can be organized as sub-arrays. The sub arrays can include columns or rows of pixels. The display data is passed to the data line 320 and the chain of segment bypass data is shifted through a set of memory cell 332. In one embodiment, the memory cell for bypass are set first and then the data are passed to the pixel memories. The bypass information for each section can be at least one bit where it sets the section to store the pixel data or bypass them to the next section. In another related embodiment, bypass information matches the section that will store the data for the pixels. Here, cell 332 compares the bypass data with the section information. If the bypass data matches the section, it will configure the section memory to store pixel data. If the bypass data does not match the section, it will configure the section to bypass the data to the next section. In another related embodiment, the bypass signal reconfigures memory connections so that the pixels that require updates are connected to a chain. The display array can have multiple chains.

The data 320 can be stored or buffered in a cell 336 before passing to the next section. The control signal 310 also can be stored or buffered in a cell 334.

The data can be passed to the memory or the next section in serial or parallel, or a combination of the two approaches.

In all segmented programing structures, the display could have two update modes. The first mode is for programming all the display areas. Here, the data does not include the segment part. If a segment is needed to be updated during segment programming mode, the data include also the segment where the data belongs. In one mode, the segment information can be the beginning and end of a sub-array that will be updated. This can be in the start point of the array and the end point. In another embodiment, this information can be the start point and the number of rows and columns form that point.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

1. A method to update a section of pixel arrays, the method comprising:
having a pixel array divided into sub-array sections includes more than one row and column;
having an independent set of programming signals for each section; and
updating a programming data for each section independently,
wherein data to update a display also includes a section that is updated wherein the data is directed to sections for updates and programming signals for that section are activated and wherein programming signals include select signals that activate a pixel for accepting programing data, emission signals that control an emission time and a frame rate of a pixel.

2. The method of claim 1 where the programming signals are arranged in rows and data lines in are arranged in columns;

3. The method of claim 1 where the sections on a right side are connected to right programming signals and sections on a left side are connected to left programming signals for a 2×2 sectional arrangement.

4. The method of claim 1 wherein the orientation of the programming signals is different.

5. (canceled)

6. The method of claim 1, wherein data signals includes biasing conditions, data inputs and frame rates.

7. (canceled)

8. The method of claim 1, wherein each section has a different emission duty cycle optimized for a brightness, power or colour of that section.

9. The method of claim 1, wherein the pixel has compensation techniques that can be controlled in section or individually wherein the compensation technique is used to improve a pixel performance such as uniformity, reliability under prolonged use or different environmental conditions such as temperature and ambient light.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)
